(19) United States
(12) Patent Application Publication
(10) Pub. No.: US 2026/0046932 A1
(43) Pub. Date: Feb. 12, 2026

(54) PRACH ADAPTATION FOR PRACH REPETITION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Jianghong LUO, Skillman, NJ (US)

(21) Appl. No.: 18/797,170

(22) Filed: Aug. 7, 2024

(51) Int. Cl. H04W 74/0833

(52) U.S. Cl. CPC H04W 74/0833

(57) ABSTRACT

A method for wireless communication at a user equipment (UE) and related apparatus are provided. In the method, the UE receives from a network entity a first indication of a first set of random access resources for a first number of random access repetitions. The UE further receives an activation indication for a second set of random access resources different from the first set of random access resources; and transmits a second number of random access repetitions in random access resources from a random access repetition group based on at least the second set of random access resources.

### TECHNICAL FIELD

The present disclosure relates generally to communication systems and, more particularly, to wireless communication including random access.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a first indication of a first set of random access resources for a first number of random access repetitions; receive an activation indication for a second set of random access resources different from the first set of random access resources; and transmit a second number of random access repetitions in random access resources from a random access repetition group based on at least the second set of random access resources.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, to a UE, a first indication of a first set of random access resources for a first number of random access repetitions; transmit an activation indication for a second set of random access resources different from the first set of random access resources; and receive a second number of random access repetitions in random access resources from a random access repetition group. The random access repetition group may be based on at least the second set of random access resources.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B illustrate example aspects of random access procedures.

FIG. 5 is a diagram illustrating an example random access occasion (RO) group for the physical random access channel (PRACH) repetition.

FIG. 6A is a diagram illustrating an example of PRACH repetition groups using the additional PRACH resources in accordance with various aspects of the present disclosure.

FIG. 6B is a diagram illustrating an example of PRACH repetition groups using the additional PRACH resources in accordance with various aspects of the present disclosure.

FIG. 7A is a diagram illustrating an example of PRACH repetition groups using the additional PRACH resources to reduce latency in accordance with various aspects of the present disclosure.

FIG. 7B is a diagram illustrating an example of PRACH repetition groups using the additional PRACH resources to improve reliability in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a diagram illustrating an example of a hardware implementation for an example apparatus and/or UE.

FIG. 14 is a diagram illustrating an example of a hardware implementation for an example network entity.

### DETAILED DESCRIPTION

In wireless communication, a random access procedure for a user equipment (UE) may be initiated by a request from higher layers or by a physical downlink control channel (PDCCH) order for a cell. To enhance the coverage or reliability, the UE may transmit a physical random access channel (PRACH) transmission including a preamble (e.g., a random access message including the preamble) with multiple repetitions. These preamble repetitions may be transmitted using a set of valid PRACH occasions, known as random access occasions (ROs), that are consecutive in time and use the same frequency resources. In some examples, the PRACH adaptation technique allows the UE to be configured with extra PRACH resources in addition to previously configured PRACH resources. Example aspects presented herein provide methods and apparatuses to support a PRACH resource grouping for PRACH repetitions when the network has configured additional PRACH resources.

Various aspects relate generally to wireless communication. Some aspects more specifically relate to PRACH adaptation for PRACH repetitions in wireless communication. In some examples, the UE may receive, from a network entity, a first indication of a first set of random access resources for a first number of random access repetitions; and receive an activation indication for a second set of random access resources different from the first set of random access resources. The UE may further transmit a second number of random access repetitions in random access resources from a random access repetition group based on at least the second set of random access resources. In some examples, the random access repetition group for the second number of random access repetitions may be an additional repetition group for the second number of random access repetitions, and resources for the second number of random access repetitions may not overlap with the first set of random access resources. In some examples, the random access repetition group for the second number of random access repetitions may be based on a combination of the first set of random access resources and the second set of random access resources.

Particular aspects of the subject matter described in this disclosure can be implemented to realize one or more of the following potential advantages. In some examples, by enabling the UE to utilize newly configured PRACH resources to perform PRACH repetitions on the earliest available occasions, the described techniques may be used to reduce the latency of the PRACH procedure. In some examples, by forming PRACH repetition groups from both existing and newly configured PRACH resources, the described techniques enable the UE to perform extra PRACH repetitions, thereby improving the reliability of the PRACH procedure. The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

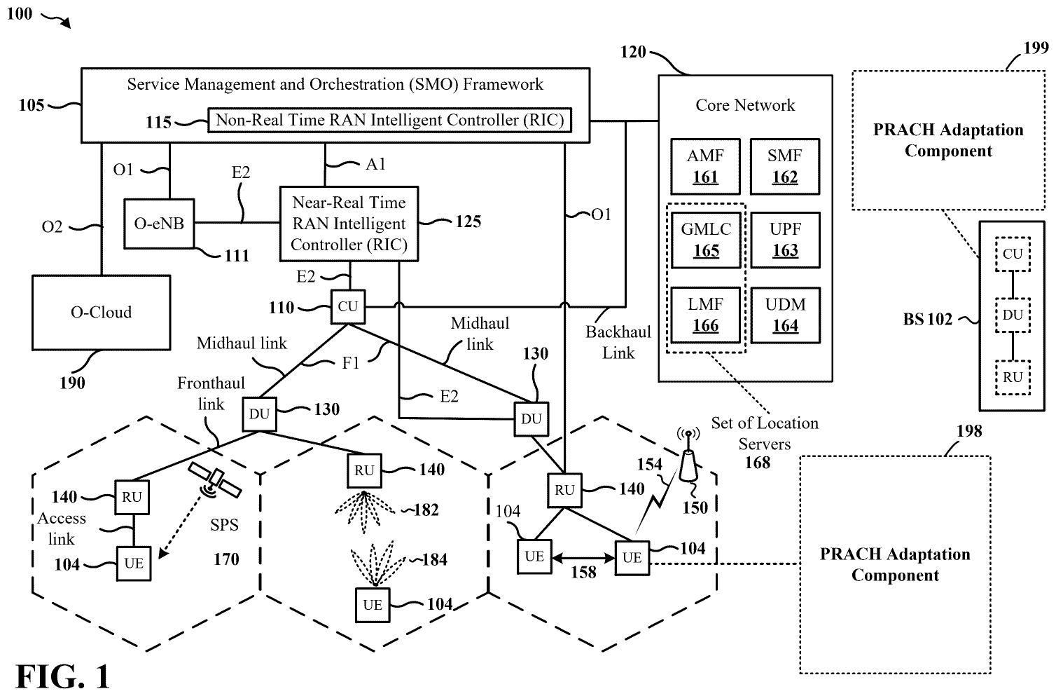

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the PRACH adaptation component 198. The PRACH adaptation component 198 may be configured to receive, from a network entity, a first indication of a first set of random access resources for a first number of random access repetitions; receive an activation indication for a second set of random access resources different from the first set of random access resources; and transmit a second number of random access repetitions in random access resources from a random access repetition group based on at least the second set of random access resources. In certain aspects, the base station 102 may include the PRACH adaptation component 199. The PRACH adaptation component 199 may be configured to transmit, to a UE, a first indication of a first set of random access resources for a first number of random access repetitions; transmit an activation indication for a second set of random access resources different from the first set of random access resources; and receive a second number of random access repetitions in random access resources from a random access repetition group. The random access repetition group may be based on at least the second set of random access resources. Although the following description may be focused on 5G NR, the concepts described herein may be applicable to other similar areas, such as LTE, LTE-A, CDMA, GSM, and other wireless technologies.

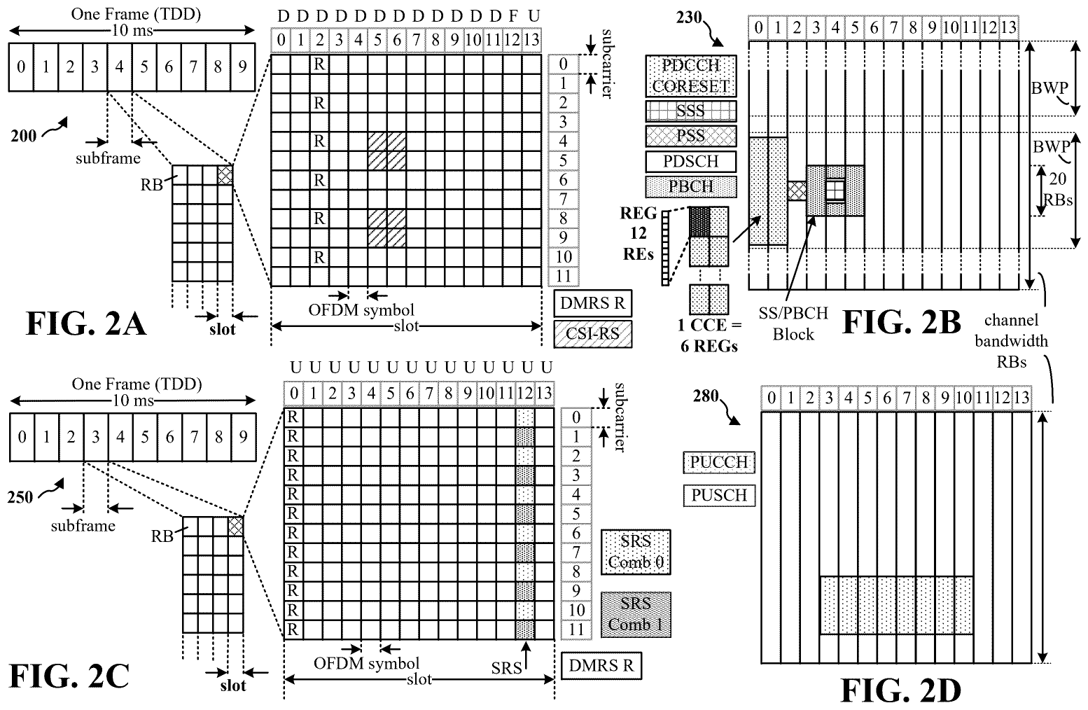

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

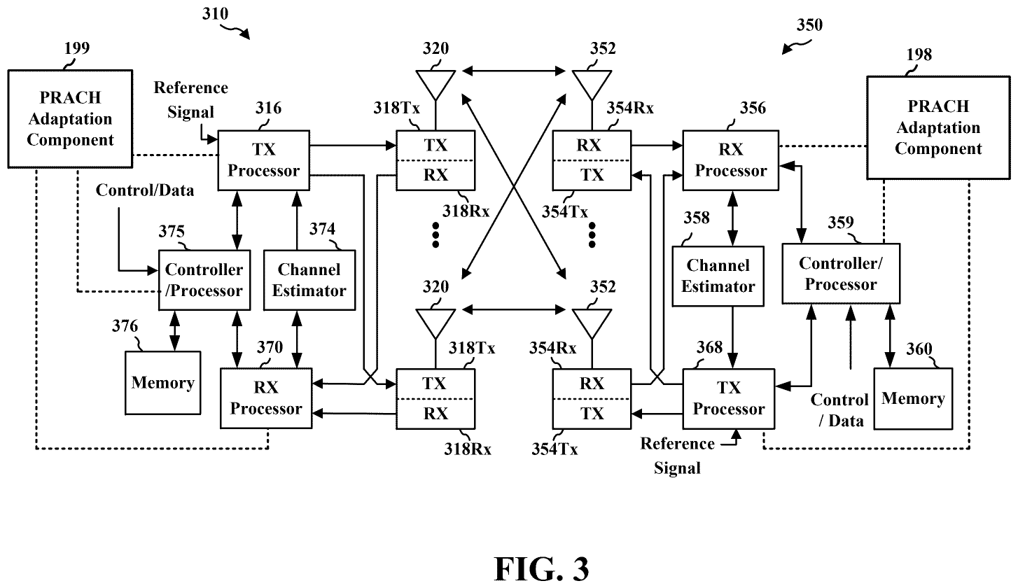

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRACH adaptation component 198 of FIG. 1.

At least one of the TX processor 316, the RX processor 370, and the controller/processor 375 may be configured to perform aspects in connection with the PRACH adaptation component 199 of FIG. 1.

In wireless communication, PRACH adaption enables the configuration of extra PRACH resources for UE on top of existing PRACH resources. Considering that PRACH repetition groups are restricted to valid random access occasions (ROs) with the same frequency allocation and the same set of preambles, employing PRACH repetition for reliability enhancement may incur a considerable PRACH latency. Example aspects presented herein propose methods and apparatus to support a PRACH resource grouping for PRACH repetition when additional PRACH resources are configured by the network.

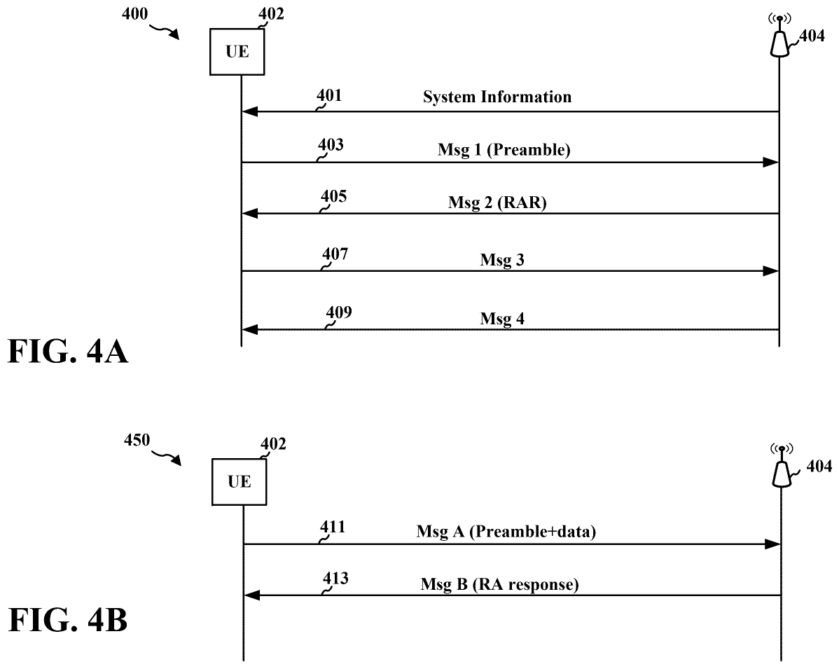

A UE may use a random access procedure in order to communicate with a base station. For example, the UE may use the random access procedure to request an RRC connection, to re-establish an RRC connection, to resume an RRC connection, etc. FIG. 4A illustrates example aspects of a random access procedure 400 between a UE 402 and a base station 404. The UE 402 may initiate the random access message exchange by sending, to the base station 404, a first random access message 403 (e.g., Msg 1) including a preamble. Prior to sending the first random access message 403, the UE 402 may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402.

The base station responds to the first random access message 403 by sending a second random access message 405 (e.g., Msg 2) using PDSCH and including a random access response (RAR). The RAR may include, e.g., an identifier of the random access preamble sent by the UE, a time advance (TA), an uplink grant for the UE to transmit data, a cell radio network temporary identifier (C-RNTI) or other identifier, and/or a back-off indicator. Upon receiving the RAR at 405, the UE 402 may transmit a third random access message 407 (e.g., Msg 3) to the base station 404, e.g., using PUSCH, that may include an RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs send the same preamble at 403, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR.

In order to reduce latency or control signaling overhead, a single round trip cycle between the UE and the base station 404 may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

In some aspects, the resource allocation for PRACH transmissions may be dynamically adaptive in the time domain. For example, the adaptation of PRACH in the time domain may include the provision of additional PRACH resources for network-energy-saving (NES) capable UEs in addition to previously configured PRACH resources that may be allocated for regular UEs (which may also be referred to as “legacy UEs,” in some aspects), and the NES capable UEs may have the flexibility to utilize both the additional PRACH resources and the previously configured PRACH resources for regular UEs. NES may refer to a mode of a base station that saves power at the base station, e.g., the base station may operate in a first mode that uses a higher amount of power at the base station, and at other times may operate in a second mode that uses a reduced amount of power at the base station. An NES capable UE may support communication with such a base station, e.g., communication with a base station while the base station is in an NES mode that saves power at the base station. In some examples, the configuration of these additional PRACH resources may be provided through semi-static signaling.

In wireless communication, a UE may initiate communication with a network (e.g., a base station) by sending a preamble message on a physical random access channel (PRACH) (e.g., in a first random access message such as a Msg 1 in FIG. 4A or Msg A in FIG. 4B). In situations where the network conditions are challenging, such as when the signal strength (e.g., the reference signal received power (RSRP) of the signal) is low or the interference is high, the UE may repeat the transmission of the preamble message multiple times, a process that may be referred to as “PRACH repetition,” to improve the coverage and the reliability of the PRACH access attempts. As an example, a number of

$${N}_{p r e a m b l e}^{r e p} > 1$$

preamble repetitions for the PRACH transmissions may be transmitted if the UE would transmit the PRACH with repetitions. For a PRACH transmission with

$${N}_{p r e a m b l e}^{r e p}$$

preamble repetitions, a set consists of

$${N}_{p r e a m b l e}^{r e p}$$

valid random access occasions (ROs) may be used for the PRACH repetitions. These ROs may be consecutive in time, use the same frequency resources, and are associated with the same synchronization signal block (SSB). The UE then may use those ROs for a number of repetitions. In some aspects, the number of repetitions may be specified.

In some examples, the PRACH repetitions may be performed on a group of ROs (or an RO group) that may include a set of

$${N}_{p r e a m b l e}^{r e p}$$

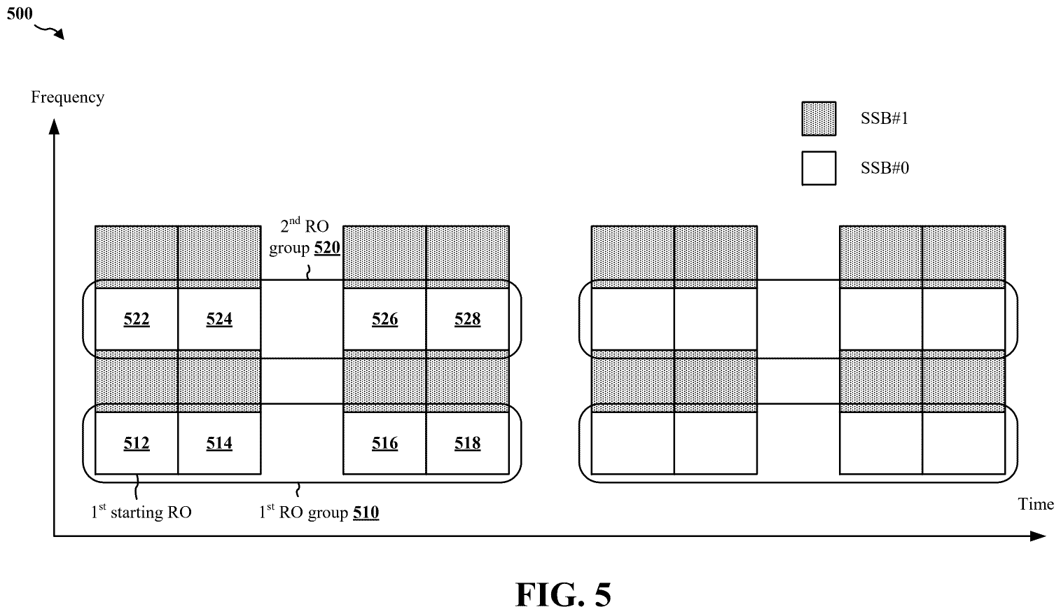

valid PRACH occasions. These PRACH occasions may be consecutive in time and use the same frequency resources. FIG. 5 is a diagram 500 illustrating an example RO group for the PRACH repetition. For example, as shown in FIG. 5, the first RO group 510 may include ROs 512, 514, 516, 518 that are consecutive in time and use the same frequency resources. The second RO group 520 may include ROs 522, 524, 526, 528 that are consecutive in time and use the same frequency resources. All the ROs in an RO group may correspond to the same SSB. The RO groups (e.g., the first RO group 510 and the second RO group 520) in FIG. 5 are for four PRACH repetitions. Hence, each RO group may include four frequency division multiplexed (FDMed) ROs. For example, the first RO group 510 may include ROs 512, 514, 516, 518.

In some examples, the PRACH adaptation enables the UE to be configured with additional PRACH resources on top of the existing PRACH resources, allowing the UE to use either the additional PRACH resources or the existing PRACH resources. The PRACH adaptation may reduce the latency by creating more ROs for the UE. For PRACH repetition, the UE may form RO groups based on the valid ROs that have the same frequency allocation and correspond to the same set of preambles. The PRACH repetition may increase the uplink coverage. In some aspects, the PRACH adaptation may be incorporated into the PRACH repetition by adapting PRACH resources and using them to create groups of PRACH resources for PRACH repetitions. For example, since PRACH repetition groups are restricted to valid ROs with the same frequency allocation and the same set of preambles, forming a group with two repetitions might introduce a delay, potentially increasing latency, while forming larger groups, such as those with four repetitions, may take even more time. To address this issue, example aspects presented herein provide methods that combine the PRACH adaptation with PRACH repetition. In some examples, the network may initially configure a sparse PRACH configuration. Although the sparse PRACH configuration may take a longer duration to form a group for a certain number of repetitions (e.g., x repetitions), it allows the network to have the flexibility to scale up and configure additional resources if it needs a larger group size for PRACH repetitions. By incorporating the adaptation of PRACH resources with the PRACH repetition, the methods may reduce latency and improve the UL coverage, thus optimizing the overall network efficiency and responsiveness.

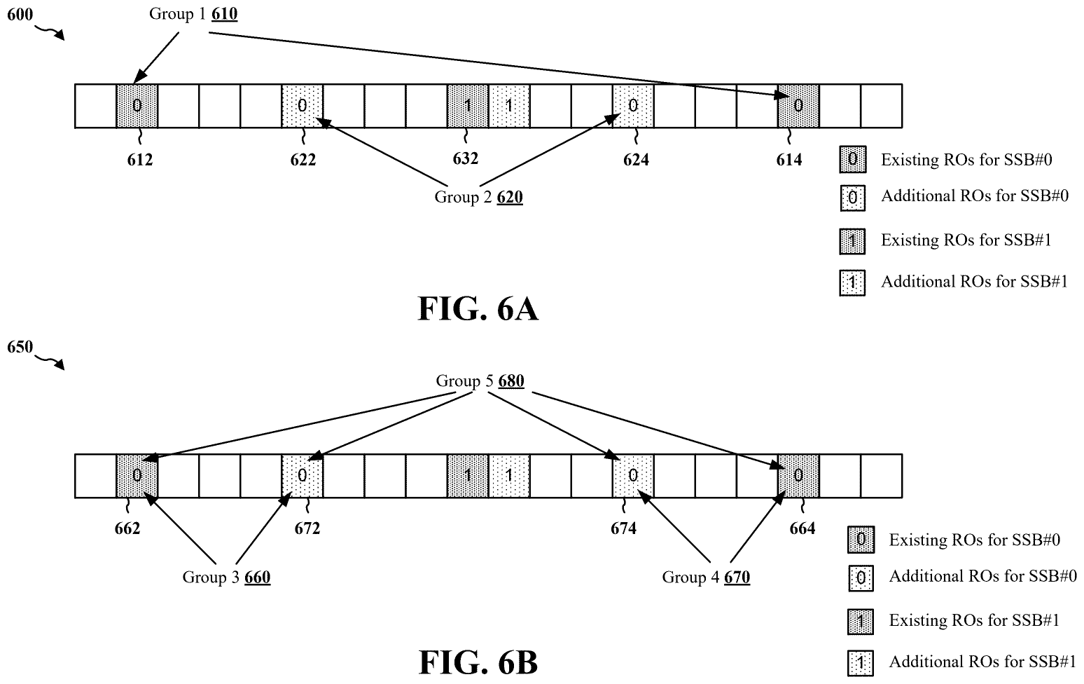

In some aspects, when additional PRACH resources are configured and activated for PRACH repetition, the UE may create PRACH repetition groups using the additional PRACH resources independently from existing groups (which may also be referred to as the “legacy groups”) for the PRACH repetitions. FIG. 6A is a diagram 600 illustrating an example of PRACH repetition groups using the additional PRACH resources in accordance with various aspects of the present disclosure. As shown in FIG. 6A, the UE may first be configured with PRACH resources, such as RO 612, 614 for SSB #0, and RO 632 for SSB #1. When additional PRACH resources (e.g., RO 622, 624) are configured and activated for PRACH repetition, the UE may create PRACH repetition groups of two repetitions (e.g., group 2 620) using the additional PRACH resources for the same SSB (e.g., RO 622, 624) independently from existing groups (e.g., group 1 610) for the PRACH repetitions. That is, the existing group (e.g., group 1 610), which may include previously configured ROs (e.g., RO 612, 614) may remain intact.

In some aspects, when additional PRACH resources are configured and activated for PRACH repetition, the UE may create PRACH repetition groups using the additional PRACH resources jointly with the existing groups for the PRACH repetitions. FIG. 6B is a diagram 650 illustrating an example of PRACH repetition groups using the additional PRACH resources in accordance with various aspects of the present disclosure. As shown in FIG. 6B, when additional PRACH resources (e.g., RO 672, 674) are configured and activated for PRACH repetition, the UE may create PRACH repetition groups for two repetitions (e.g., group 3 660, group 4 670) using the additional PRACH resources jointly with the existing groups for the PRACH repetitions for the same SSB. For example, the UE may create a group of two repetitions (e.g., group 3 660) using the additional RO 672 and the existing RO 662, or create another group of two repetitions (e.g., group 4 670) using the additional RO 674 and the exiting RO 664. In some examples, the UE may create a group of four repetitions (e.g., group 5 680) using the using the additional RO 672, 674, and the exiting RO 662, 664.

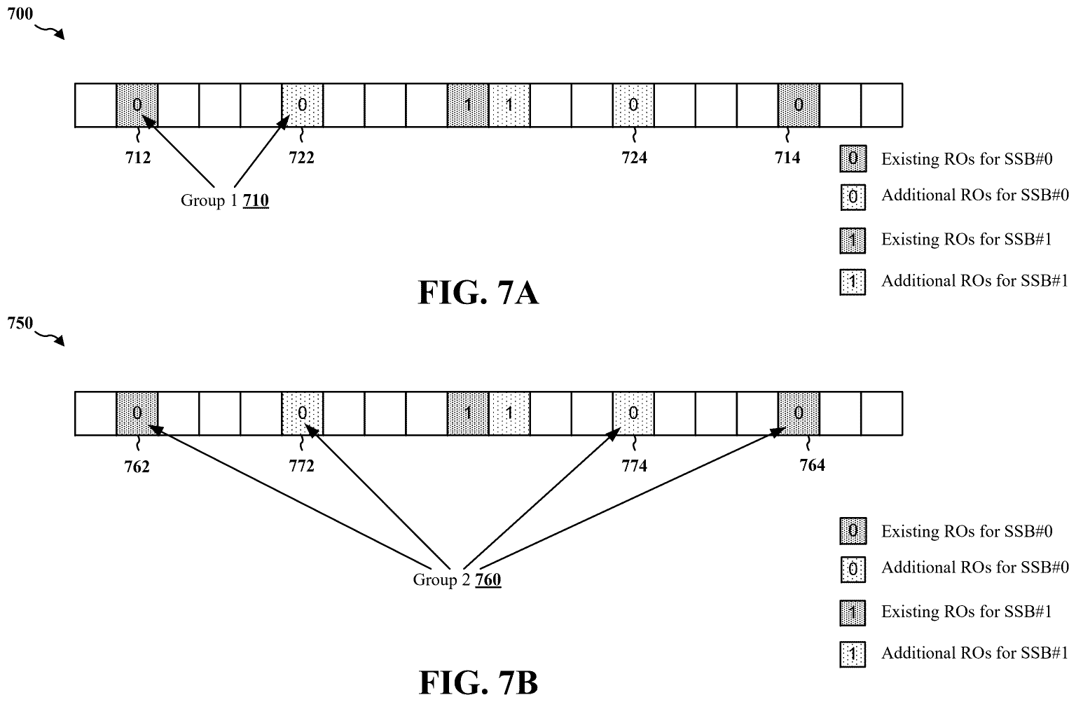

In some examples, when the UE creates PRACH repetition groups using the additional PRACH resources jointly with the existing groups for the PRACH repetitions, the creation of the PRACH repetition groups may be contingent upon a grouping condition being met. For example, the grouping condition may include the additional PRACH resources and the existing groups for the PRACH repetitions have the same frequency allocation of ROs or share the same preamble set per RO. For example, when the UE creates PRACH repetition group 1 660 using the additional RO 672 jointly with the existing RO 662, the additional RO 672 and the existing RO 662 may have the same frequency allocation or share the same preamble set per RO. In some examples, when additional PRACH resources are used jointly with the existing PRACH resources to create the PRACH repetition group, the additional PRACH resources may be used to reduce the latency. For example, the latency may be reduced by creating the same number of repetitions as the existing PRACH resources from both the additional PRACH resources and existing PRACH resources in the shortest possible time. FIG. 7A is a diagram 700 illustrating an example of PRACH repetition groups using the additional PRACH resources to reduce latency in accordance with various aspects of the present disclosure. As shown in FIG. 7A, if the UE determines that two PRACH repetitions are necessary (e.g., based on the RSRP of the received signal), the UE may create a PRACH repetition group (e.g., group 1 710) using the earliest available ROs (e.g., RO 712, 722) from both the additional PRACH resources (e.g., RO 722) and the existing PRACH resources (e.g., RO 712). Compared to using the PRACH repetition group based on the existing PRACH resources (e.g., RO 712 and 714), using the PRACH repetition group (e.g., group 1 710) based on both the additional PRACH resources and the existing PRACH resources may reduce the latency as the UE may complete PRACH repetitions in a shorter time duration.

In one configuration, when additional PRACH resources are used jointly with the existing PRACH resources to create the PRACH repetition group, the additional PRACH resources may be used to improve the reliability. For example, the network reliability may be increased by allowing the UE to transmit the same number of repetitions over a group of PRACH resources in an existing PRACH group, while also sending additional PRACH repetitions through the additional PRACH resources, all within the same timeframe of the original number of repetitions. FIG. 7B is a diagram 750 illustrating an example of PRACH repetition groups using the additional PRACH resources to improve reliability in accordance with various aspects of the present disclosure. As shown in FIG. 7B, the UE may transmit two repetitions over a group of two PRACH resources (e.g., RO 762, 764) in an existing PRACH group. Additionally, the UE may further transmit additional two PRACH repetitions through the additional PRACH resources (e.g., RO 772, 774), all within the same timeframe of the original number of repetitions (e.g., two repetitions). Compared to using the PRACH repetition group based on the existing PRACH resources (e.g., RO 762 and 76), using the PRACH repetition group (e.g., group 2 760) based on both the additional PRACH resources and the existing PRACH resources may improve the reliability as the UE may transmit more PRACH repetitions within the same timeframe of the original number of repetitions.

In some examples, the summation of the original number of repetitions and the additional PRACH repetition may not exceed a maximum number. For example, in FIG. 7B, the summation of the original number of repetitions (e.g., two repetitions based on RO 762, 764) and the additional PRACH repetition (e.g., two additional repetitions based on RO 772, 774) may not exceed a maximum number. In some examples, the UE may receive, from the network entity, a configuration indicative of the maximum number.

In some aspects, when the network activates the additional PRACH resources, the network may indicate whether the additional PRACH resources should be utilized to create groups independently (as shown in FIG. 6A) or jointly with existing PRACH resources (as shown in FIG. 6B). When the additional PRACH resources are utilized jointly with existing PRACH resources (e.g., as shown in FIG. 6B), the network may further indicate the UE whether the additional PRACH resources is to be used to reduce the latency or to increase reliability. For example, when the network activates the additional PRACH resources (e.g., RO 622, 624, 672, 674) via an activation indication, the activation indication may include information indicating whether the additional PRACH resources (e.g., RO 622, 624, 672, 674) should be utilized to create groups independently or jointly with existing PRACH resources (e.g., RO 612, 614, 662, 664). For example, the activation indication may include a group indicator. The group indicator may have one of a first group value or a second group value. The first group value may indicate that the additional PRACH resources is to be utilized to create groups independently from existing PRACH resources (e.g., the resources in the created groups do not overlap with the existing PRACH resources), and the second group value may indicate that the additional PRACH resources may be utilized to create groups jointly with existing PRACH resources. In some examples, Additionally, when the additional PRACH resources are utilized jointly with existing PRACH resources, the activation indication may further include information indicating whether the group is going to be designed to reduce the latency or increase reliability. For example, the activation indication may include a scheme indicator. The scheme indicator may have one of a first scheme value or a second scheme value. The first scheme value may indicate the additional PRACH resources is to be used to reduce the latency, and the second scheme value may indicate the additional PRACH resources is to be used to increase reliability.

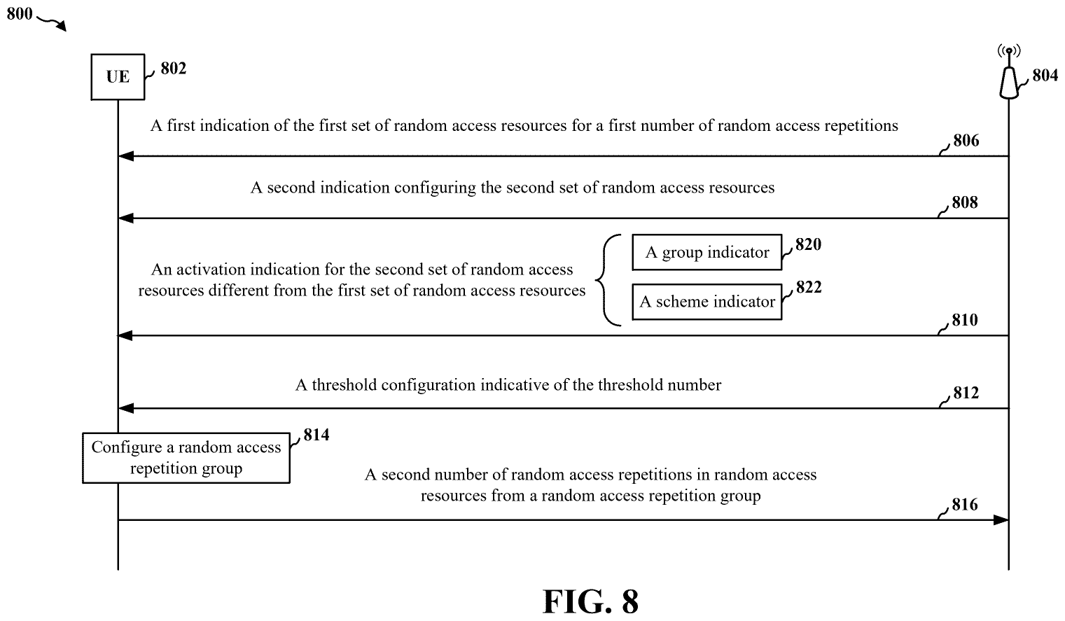

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., a CU 110, a DU 130, and/or an RU 140).

As shown in FIG. 8, at 806, a UE 802 may receive, from base station 804, a first indication of a first set of random access resources for a first number of random access repetitions. For example, referring to FIG. 6A, a UE 802 may receive a first indication of a first set of random access resources (e.g., RO 612, 614) for a first number (e.g., two) of random access repetitions.

At 808, the UE 802 may receive, from base station 804, a second indication. The second indication may configure the second set of random access resources. The second set of random access resources may be different from the first set of random access resources. For example, referring to FIG. 6A, the second set of random access resources may include RO 622, 624, which may be different from the first set of random access resources (e.g., RO 612, 614, 632).

At 810, the UE 802 may receive, from base station 804, an activation indication for the second set of random access resources. The activation indication may active the second set of random access resources (e.g., RO 622, 624, 672, 674). In some examples, the activation indication may further include a group indicator (at 820) and a scheme indicator (at 822). The group indicator may have one of a first group value or a second group value. The first group value may indicate that the second set of random access resources (e.g., RO 622, 624, 672, 674) is to be utilized to create groups independently from the first set of random access resources (e.g., RO 612, 614, 662, 664), and the second group value may indicate that the second set of random access resources (e.g., RO 622, 624, 672, 674) may be utilized to create groups jointly with the first set of random access resources (e.g., RO 612, 614, 662, 664). The scheme indicator may have one of a first scheme value or a second scheme value. The first scheme value may indicate the second set of random access resources (e.g., RO 622, 624, 672, 674) is to be used to reduce the latency, and the second scheme value may indicate the second set of random access resources (e.g., RO 622, 624, 672, 674) is to be used to increase reliability.

At 812, the UE 802 may receive, from base station 804, a threshold configuration indicative of a threshold number. For example, when transmitting the random access repetitions (e.g., at 816), the total number of random access repetitions may be less than the threshold number. For example, referring to FIG. 7B, the total number of random access repetitions (e.g., four repetitions based on group 2 760) may be less than the threshold number.

At 814, the UE 802 may configure a random access repetition group based on at least the second set of random access resources. For example, referring to FIG. 6A, the UE may configure a random access repetition group (e.g., group 2 620) based on the second set of random access resources (e.g., RO 622, 624) and independent of the first set of random access resources (e.g., RO 612, 614). Referring to FIG. 6B, the UE may configure a random access repetition group (e.g., group 3 660) based on the first set of random access resources (e.g., RO 662) and the second set of random access resources (e.g., RO 672).

At 816, the UE 802 may transmit the second number of random access repetitions in random access resources from the random access repetition group based on at least the second set of random access resources. For example, referring to FIG. 7A, the UE may transmit the second number of random access repetitions (e.g., two repetitions) in ROs 712, 722, which are based on at least the second set of random access resources (e.g., RO 722, 724). Referring to FIG. 7B, the UE may transmit the second number of random access repetitions (e.g., four repetitions) in ROs 762, 772, 774, 764, which are based on at least the second set of random access resources (e.g., RO 772, 774).

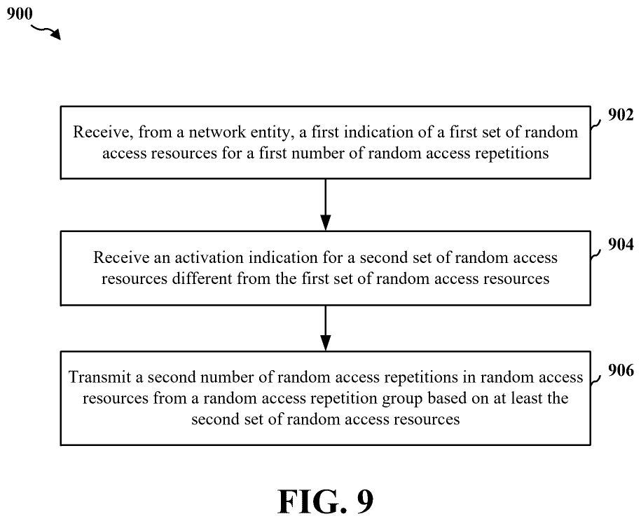

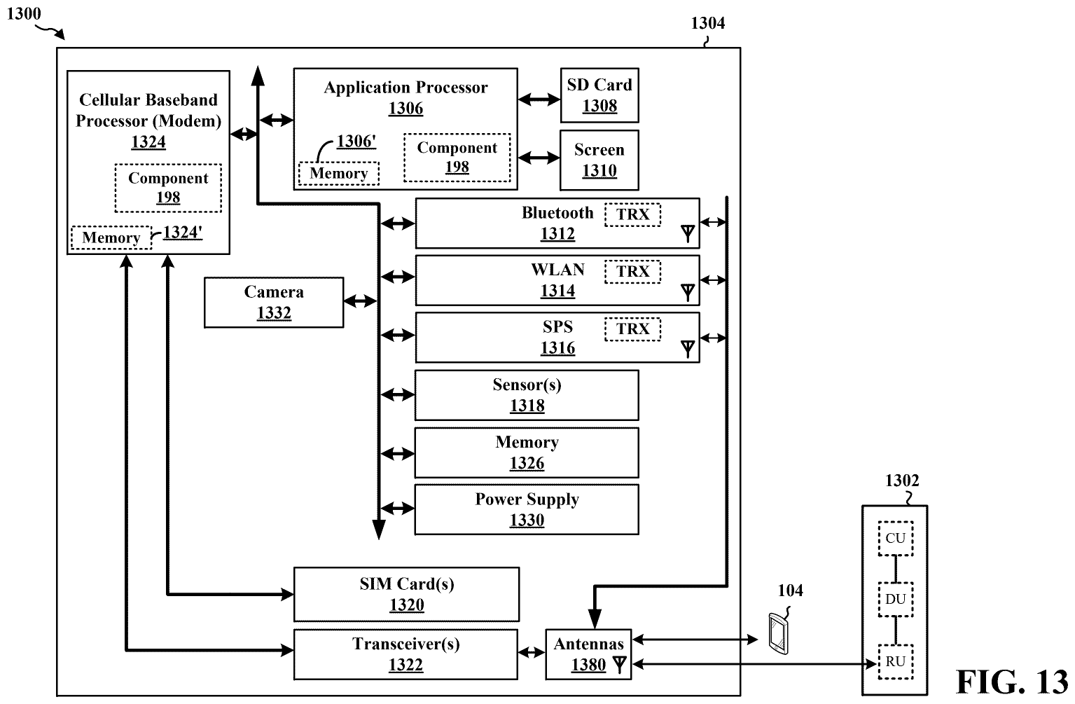

FIG. 9 is a flowchart 900 illustrating methods of wireless communication at a UE in accordance with various aspects of the present disclosure. The method may be performed by a UE. The UE may be the UE 104, 350, 802, or the apparatus 1304 in the hardware implementation of FIG. 13. By enabling the UE to utilize newly configured PRACH resources to perform PRACH repetitions on the earliest available occasions, the methods reduce the latency of the PRACH procedure. Additionally, by forming PRACH repetition groups from both existing and newly configured PRACH resources, the methods enable the UE to perform extra PRACH repetitions, thereby improving the reliability of the PRACH procedure.

As shown in FIG. 9, at 902, the UE may receive, from a network entity, a first indication of a first set of random access resources for a first number of random access repetitions. The network entity may be a base station, or a component of a base station, in the access network of FIG. 1 or a core network component (e.g., base station 102, 310, 804; or the network entity 1302 in the hardware implementation of FIG. 13). FIG. 6A, FIG. 6B, FIG. 7A, FIG. 7B, and FIG. 8 illustrate various aspects of the steps in connection with flowchart 900. For example, referring to FIG. 8, the UE 802 may, at 806, receive, from a network entity (base station 804), a first indication of a first set of random access resources for a first number of random access repetitions. Referring to FIG. 6A, a UE may receive a first indication of a first set of random access resources (e.g., RO 612, 614) for a first number (e.g., two) of random access repetitions. In some aspects, 902 may be performed by the PRACH adaptation component 198.

At 904, the UE may receive an activation indication for a second set of random access resources different from the first set of random access resources. For example, referring to FIG. 8, the UE 802 may, at 810, receive an activation indication for a second set of random access resources different from the first set of random access resources. Referring to FIG. 6A and FIG. 6B, the activation indication may active the second set of random access resources (e.g., RO 622, 624, 672, 674). In some aspects, 904 may be performed by the PRACH adaptation component 198.

At 906, the UE may transmit a second number of random access repetitions in random access resources from a random access repetition group based on at least the second set of random access resources. For example, referring to FIG. 8, the UE 802 may, at 816, transmit a second number of random access repetitions in random access resources from a random access repetition group based on at least the second set of random access resources. Referring to FIG. 7A, the UE may transmit the second number of random access repetitions (e.g., two repetitions) in ROs 712, 722, which are based on the second set of random access resources (e.g., RO 722, 724). Referring to FIG. 7B, the UE may transmit the second number of random access repetitions (e.g., four repetitions) in ROs 762, 772, 774, 764, which are based on the second set of random access resources (e.g., RO 772, 774). In some aspects, 906 may be performed by the PRACH adaptation component 198.

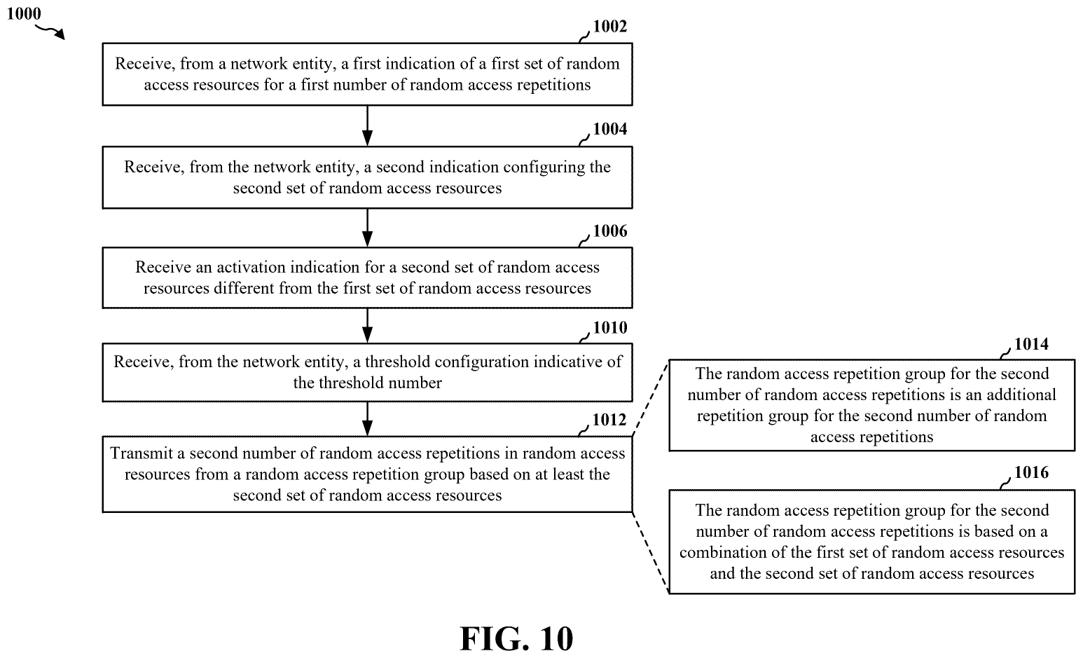

FIG. 10 is a flowchart 1000 illustrating methods of wireless communication at a UE in accordance with various aspects of the present disclosure. The method may be performed by a UE. The UE may be the UE 104, 350, 802, or the apparatus 1304 in the hardware implementation of FIG. 13. By enabling the UE to utilize newly configured PRACH resources to perform PRACH repetitions on the earliest available occasions, the methods reduce the latency of the PRACH procedure. Additionally, by forming PRACH repetition groups from both existing and newly configured PRACH resources, the methods enable the UE to perform extra PRACH repetitions, thereby improving the reliability of the PRACH procedure.

As shown in FIG. 10, at 1002, the UE may receive, from a network entity, a first indication of a first set of random access resources for a first number of random access repetitions. The network entity may be a base station, or a component of a base station, in the access network of FIG. 1 or a core network component (e.g., base station 102, 310, 804; or the network entity 1302 in the hardware implementation of FIG. 13). FIG. 6A, FIG. 6B, FIG. 7A, FIG. 7B, and FIG. 8 illustrate various aspects of the steps in connection with flowchart 1000. For example, referring to FIG. 8, the UE 802 may, at 806, receive, from a network entity (base station 804), a first indication of a first set of random access resources for a first number of random access repetitions. Referring to FIG. 6A, a UE may receive a first indication of a first set of random access resources (e.g., RO 612, 614) for a first number (e.g., two) of random access repetitions. In some aspects, 1002 may be performed by the PRACH adaptation component 198.

At 1006, the UE may receive an activation indication for a second set of random access resources different from the first set of random access resources. For example, referring to FIG. 8, the UE 802 may, at 810, receive an activation indication for a second set of random access resources different from the first set of random access resources. Referring to FIG. 6A and FIG. 6B, the activation indication may active the second set of random access resources (e.g., RO 622, 624, 672, 674). In some aspects, 1006 may be performed by the PRACH adaptation component 198.

At 1012, the UE may transmit a second number of random access repetitions in random access resources from a random access repetition group based on at least the second set of random access resources. For example, referring to FIG. 8, the UE 802 may, at 816, transmit a second number of random access repetitions in random access resources from a random access repetition group based on at least the second set of random access resources. Referring to FIG. 7A, the UE may transmit the second number of random access repetitions (e.g., two repetitions) in ROs 712, 722, which are based on the second set of random access resources (e.g., RO 722, 724). Referring to FIG. 7B, the UE may transmit the second number of random access repetitions (e.g., four repetitions) in ROs 762, 772, 774, 764, which are based on the second set of random access resources (e.g., RO 772, 774). In some aspects, 1012 may be performed by the PRACH adaptation component 198.

In some aspects, each random access resource in the first set of random access resources and the second set of random access resources may correspond to at least one RO. For example, referring to FIG. 6A, each random access resource in the first set of random access resources (e.g., RO 612, 614) and the second set of random access resources (e.g., RO 622, 624) may correspond to at least one RO (e.g., RO 612, 614 or RO 622, 624).

In some aspects, at 1004, the UE may receive, from the network entity, a second indication configuring the second set of random access resources. For example, referring to FIG. 8, the UE 802 may, at 808 receive, from the network entity (base station 804), a second indication configuring the second set of random access resources. Referring to FIG. 6A, the second set of random access resources may include RO 622, 624, which may be different from the first set of random access resources (e.g., RO 612, 614). In some aspects, 1004 may be performed by the PRACH adaptation component 198.

In some aspects, the random access repetition group for the second number of random access repetitions may be an additional repetition group for the second number of random access repetitions (at 1014), and resources for the second number of random access repetitions may not overlap with the first set of random access resources. For example, referring to FIG. 6A, the random access repetition group (e.g., group 2 620) for the second number of random access repetitions may be an additional repetition group for the second number of random access repetitions, and resources for the second number of random access repetitions (e.g., RO 622, 624) may not overlap with the first set of random access resources (e.g., RO 612, 614).

In some aspects, the activation indication may include a group indicator. The group indicator may have a value (e.g., a first indication value) that indicates the resources for the second number of random access repetitions do not overlap with the first set of random access resources. For example, referring to FIG. 8, the activation indication (at 810) may include a group indicator 820. The group indicator 820 may have a value (e.g., a first indication value) that indicates the resources for the second number of random access repetitions (e.g., RO 622, 624) do not overlap with the first set of random access resources (e.g., RO 612, 614).

In some aspects, the random access repetition group for the second number of random access repetitions may be based on a combination of the first set of random access resources and the second set of random access resources (at 1016). For example, referring to FIG. 6B, the random access repetition group (e.g., group 3 660, group 4 670) for the second number of random access repetitions may be based on a combination of the first set of random access resources (e.g., RO 662, 664) and the second set of random access resources (e.g., RO 672, 674).

In some aspects, the activation indication may include a group indicator. The group indicator may have a value (e.g., a second indication value) that indicates the random access repetition group is based on the combination. For example, referring to FIG. 8, the activation indication (at 810) may include a group indicator 820. The group indicator may have a value that indicates the random access repetition group (e.g., group 3 660) is based on the combination of the first set of random access resources (e.g., RO 662) and the second set of random access resources (e.g., RO 672).

In some aspects, the activation indication may include a scheme indicator. The scheme indicator may have one of a first value or a second value. The first value may indicate that the random access repetition group is for reduced latency, and the second value may indicate that the random access repetition group is for increased reliability. For example, referring to FIG. 8, the activation indication (at 810) may include a scheme indicator 822. The scheme indicator 822 may have one of a first value or a second value. The first value may indicate that the random access repetition group is for reduced latency, and the second value may indicate that the random access repetition group is for increased reliability.

In some aspects, the combination of the first set of random access resources and the second set of random access resources may be based on a grouping condition. For example, referring to FIG. 6B, the combination of the first set of random access resources (e.g., RO 662) and the second set of random access resources (e.g., RO 672) may be based on a grouping condition.

In some aspects, the grouping condition may include at least one of: the random access resources in the first set of random access resources are located at a same frequency range as the random access resources in the second set of random access resources, or each random access resource in the first set of random access resources is associated with a same preamble set as each random access resource in the second set of random access resources. For example, referring to FIG. 6B, the grouping condition may include at least one of: the random access resources in the first set of random access resources (e.g., RO 662) are located at a same frequency range as the random access resources in the second set of random access resources (e.g., RO 672), or each random access resource in the first set of random access resources (e.g., RO 662) is associated with a same preamble set as each random access resource in the second set of random access resources (e.g., RO 672).

In some aspects, to transmit the second number of random access repetitions (at 1012), the UE may transmit the second number of random access repetitions using the carliest available random access resources in the combination of the first set of random access resources and the second set of random access resources. For example, referring to FIG. 7A, the UE may transmit the second number (e.g., two repetitions) of random access repetitions using the earliest available random access resources (e.g., RO 712, 722) in the combination of the first set of random access resources (e.g., RO 712, 714) and the second set of random access resources (e.g., RO 722, 724).

In some aspects, the second number of random access repetitions may equal the first number of random access repetitions. For example, referring to FIG. 7A, the second number of random access repetitions and the first number of random access repetitions may both be two random access repetitions.

In some aspects, to transmit the second number of random access repetitions (at 1012), the UE may transmit the second number of random access repetitions in addition to the first number of random access repetitions in a time range of the first number of random access repetitions. For example, referring to FIG. 7B, the UE may transmit the second number of random access repetitions (e.g., two repetitions using RO 772, 774) in addition to the first number of random access repetitions (e.g., two repetitions using RO 762, 764) in a time range of the first number of random access repetitions.

In some aspects, the summation of the first number of repetitions and the second number of repetitions may be less than a threshold number. For example, referring to FIG. 7B, the summation of the first number of repetitions (e.g., two repetitions using RO 762, 764) and the second number of repetitions (e.g., two repetitions using RO 772, 774) may be less than a threshold number.

In some aspects, at 1010, the UE may receive, from the network entity, a threshold configuration indicative of the threshold number. For example, referring to FIG. 8, the UE 802 may, at 812, receive, from the network entity (base station 804), a threshold configuration indicative of the threshold number. In some aspects, 1010 may be performed by the PRACH adaptation component 198.

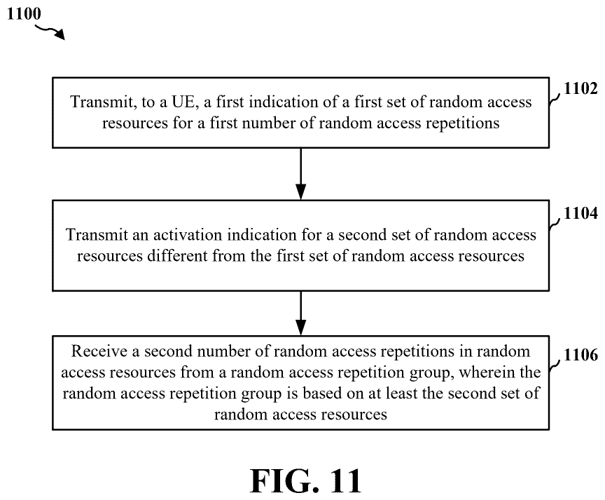

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). By enabling the UE to utilize newly configured PRACH resources to perform PRACH repetitions on the earliest available occasions, the methods reduce the latency of the PRACH procedure. Additionally, by forming PRACH repetition groups from both existing and newly configured PRACH resources, the methods enable the UE to perform extra PRACH repetitions, thereby improving the reliability of the PRACH procedure.

As shown in FIG. 11, at 1102, the network entity may transmit, to a UE, a first indication of a first set of random access resources for a first number of random access repetitions. The UE may be the UE 104, 350, 802, or the apparatus 1304 in the hardware implementation of FIG. 13. FIG. 6A, FIG. 6B, FIG. 7A, FIG. 7B, and FIG. 8 illustrate various aspects of the steps in connection with flowchart 1100. For example, referring to FIG. 8, the network entity (base station 804) may, at 806, transmit, to a UE 802, a first indication of a first set of random access resources for a first number of random access repetitions. Referring to FIG. 6A, the first set of random access resources may include RO 612, 614 for a first number (e.g., two) of random access repetitions. In some aspects, 1102 may be performed by the PRACH adaptation component 199.

At 1104, the network entity may transmit an activation indication for a second set of random access resources different from the first set of random access resources. For example, referring to FIG. 8, the network entity (base station 804) may, at 810, transmit an activation indication for a second set of random access resources different from the first set of random access resources. Referring to FIG. 6A and FIG. 6B, the activation indication may active the second set of random access resources (e.g., RO 622, 624, 672, 674). In some aspects, 1104 may be performed by the PRACH adaptation component 199.

At 1106, the network entity may receive a second number of random access repetitions in random access resources from a random access repetition group. The random access repetition group may be based on at least the second set of random access resources. For example, referring to FIG. 8, the network entity (base station 804) may, at 816, receive a second number of random access repetitions in random access resources from a random access repetition group. Referring to FIG. 7A, the base station may receive the second number of random access repetitions (e.g., two repetitions) in ROs 712, 722, which are based on at least the second set of random access resources (e.g., RO 722, 724). Referring to FIG. 7B, the base station may transmit the second number of random access repetitions (e.g., four repetitions) in ROs 762, 772, 774, 764, which are based on at least the second set of random access resources (e.g., RO 772, 774). In some aspects, 1106 may be performed by the PRACH adaptation component 199.

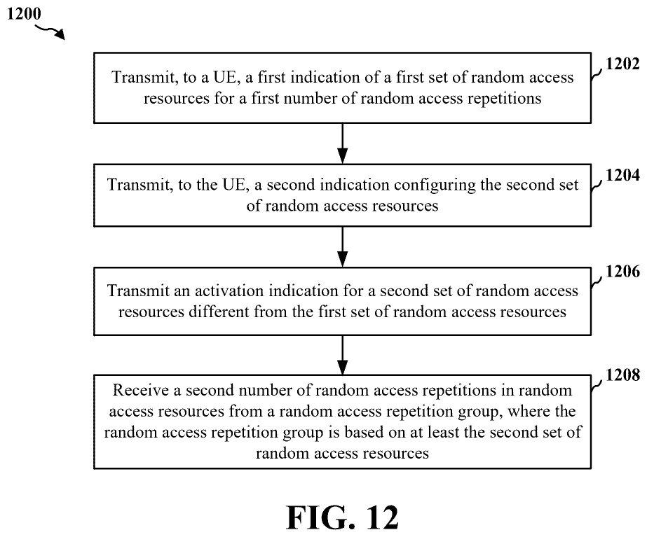

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). By enabling the UE to utilize newly configured PRACH resources to perform PRACH repetitions on the earliest available occasions, the methods reduce the latency of the PRACH procedure. Additionally, by forming PRACH repetition groups from both existing and newly configured PRACH resources, the methods enable the UE to perform extra PRACH repetitions, thereby improving the reliability of the PRACH procedure.

As shown in FIG. 12, at 1202, the network entity may transmit, to a UE, a first indication of a first set of random access resources for a first number of random access repetitions. The UE may be the UE 104, 350, 802, or the apparatus 1304 in the hardware implementation of FIG. 13. FIG. 6A, FIG. 6B, FIG. 7A, FIG. 7B, and FIG. 8 illustrate various aspects of the steps in connection with flowchart 1200. For example, referring to FIG. 8, the network entity (base station 804) may, at 806, transmit, to a UE 802, a first indication of a first set of random access resources for a first number of random access repetitions. Referring to FIG. 6A, the first set of random access resources may include RO 612, 614 for a first number (e.g., two) of random access repetitions. In some aspects, 1202 may be performed by the PRACH adaptation component 199.

At 1206, the network entity may transmit an activation indication for a second set of random access resources different from the first set of random access resources. For example, referring to FIG. 8, the network entity (base station 804) may, at 810, transmit an activation indication for a second set of random access resources different from the first set of random access resources. Referring to FIG. 6A and FIG. 6B, the activation indication may active the second set of random access resources (e.g., RO 622, 624, 672, 674). In some aspects, 1206 may be performed by the PRACH adaptation component 199.

At 1208, the network entity may receive a second number of random access repetitions in random access resources from a random access repetition group. The random access repetition group may be based on at least the second set of random access resources. For example, referring to FIG. 8, the network entity (base station 804) may, at 816, receive a second number of random access repetitions in random access resources from a random access repetition group. Referring to FIG. 7A, the base station may receive the second number of random access repetitions (e.g., two repetitions) in ROs 712, 722, which are based on at least the second set of random access resources (e.g., RO 722, 724). Referring to FIG. 7B, the base station may transmit the second number of random access repetitions (e.g., four repetitions) in ROs 762, 772, 774, 764, which are based on at least the second set of random access resources (e.g., RO 772, 774). In some aspects, 1208 may be performed by the PRACH adaptation component 199.

In some aspects, each random access resource in the first set of random access resources and the second set of random access resources may correspond to at least one RO. For example, referring to FIG. 6A, each random access resource in the first set of random access resources (e.g., RO 612, 614) and the second set of random access resources (e.g., RO 622, 624) may correspond to at least one RO (e.g., RO 612, 614 or RO 622, 624).

In some aspects, at 1204, the network entity may transmit, to the UE, a second indication configuring the second set of random access resources. For example, referring to FIG. 8, the network entity (base station 804) may, at 808, transmit, to the UE 802, a second indication configuring the second set of random access resources. In some aspects, 1204 may be performed by the PRACH adaptation component 199.

In some aspects, the random access repetition group for the second number of random access repetitions may be an additional repetition group for the second number of random access repetitions, and the resources for the second number of random access repetitions do not overlap with the first set of random access resources. For example, referring to FIG. 6A, the random access repetition group (e.g., group 2 620) for the second number of random access repetitions may be an additional repetition group for the second number of random access repetitions, and resources for the second number of random access repetitions (e.g., RO 622, 624) may not overlap with the first set of random access resources (e.g., RO 612, 614).

In some aspects, the activation indication may include a group indicator. The group indicator may have a value (e.g., a first indication value) that indicates the resources for the second number of random access repetitions do not overlap with the first set of random access resources. For example, referring to FIG. 8, the activation indication (at 810) may include a group indicator 820. The group indicator 820 may have a value (e.g., a first indication value) that indicates the resources for the second number of random access repetitions (e.g., RO 622, 624) do not overlap with the first set of random access resources (e.g., RO 612, 614).

In some aspects, the random access repetition group for the second number of random access repetitions may be based on a combination of the first set of random access resources and the second set of random access resources. For example, referring to referring to FIG. 6B, the random access repetition group (e.g., group 3 660, group 4 670) for the second number of random access repetitions may be based on a combination of the first set of random access resources (e.g., RO 662, 664) and the second set of random access resources (e.g., RO 672, 674).

In some aspects, the activation indication may include a group indicator. The group indicator may have a value (e.g., a second indication value) that indicates the random access repetition group is based on the combination. For example, referring to FIG. 8, the activation indication (at 810) may include a group indicator 820. The group indicator may have a value that indicates the random access repetition group (e.g., group 3 660) is based on the combination of the first set of random access resources (e.g., RO 662) and the second set of random access resources (e.g., RO 672).

In some aspects, the activation indication may include a scheme indicator. The scheme indicator may have one of a first value or a second value. The first value may indicate that the random access repetition group is for reduced latency, and the second value may indicate that the random access repetition group is for increased reliability. For example, referring to FIG. 8, the activation indication (at 810) may include a scheme indicator 822. The scheme indicator 822 may have one of a first value or a second value. The first value may indicate that the random access repetition group is for reduced latency, and the second value may indicate that the random access repetition group is for increased reliability.

In some aspects, the combination of the first set of random access resources and the second set of random access resources may be based on a grouping condition. For example, referring to FIG. 6B, the combination of the first set of random access resources (e.g., RO 662) and the second set of random access resources (e.g., RO 672) may be based on a grouping condition.

In some aspects, the grouping condition may include at least one of: the random access resources in the first set of random access resources are located at a same frequency range as the random access resources in the second set of random access resources, or each random access resource in the first set of random access resources is associated with a same preamble set as each random access resource in the second set of random access resources. For example, referring to FIG. 6B, the grouping condition may include at least one of: the random access resources in the first set of random access resources (e.g., RO 662) are located at a same frequency range as the random access resources in the second set of random access resources (e.g., RO 672), or each random access resource in the first set of random access resources (e.g., RO 662) is associated with a same preamble set as each random access resource in the second set of random access resources (e.g., RO 672).

In some aspects, the second number of random access repetitions may use earliest available random access resources in the combination of the first set of random access resources and the second set of random access resources. For example, referring to FIG. 7A, the second number (e.g., two repetitions) of random access repetitions may use earliest available random access resources (e.g., RO 712, 722) in the combination of the first set of random access resources (e.g., RO 712, 714) and the second set of random access resources (e.g., RO 722, 724).

In some aspects, the second number of random access repetitions may equal the first number of random access repetitions. For example, referring to FIG. 7A, the second number of random access repetitions and the first number of random access repetitions may both be two random access repetitions.

In some aspects, the second number of random access repetitions may be in addition to the first number of random access repetitions in a time range of the first number of random access repetitions. For example, referring to FIG. 7B, the second number of random access repetitions (e.g., two repetitions using RO 772, 774) are in addition to the first number of random access repetitions (e.g., two repetitions using RO 762, 764) in a time range of the first number of random access repetitions.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor (or processing circuitry) 1324 (also referred to as a modem) coupled to one or more transceivers 1322 (e.g., cellular RF transceiver). The cellular baseband processor(s) (or processing circuitry) 1324 may include at least one on-chip memory (or memory circuitry) 1324′. In some aspects, the apparatus 1304 may further include one or more subscriber identity modules (SIM) cards 1320 and at least one application processor (or processing circuitry) 1306 coupled to a secure digital (SD) card 1308 and a screen 1310. The application processor(s) (or processing circuitry) 1306 may include on-chip memory (or memory circuitry) 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) (or processing circuitry) 1324 communicates through the transceiver(s) 1322 via one or more antennas 1380 with the UE 104 and/or with an RU associated with a network entity 1302. The cellular baseband processor(s) (or processing circuitry) 1324 and the application processor(s) (or processing circuitry) 1306 may each include a computer-readable medium/memory (or memory circuitry) 1324′, 1306′, respectively. The additional memory modules 1326 may also be considered a computer-readable medium/memory (or memory circuitry). Each computer-readable medium/memory (or memory circuitry) 1324′, 1306′, 1326 may be non-transitory. The cellular baseband processor(s) (or processing circuitry) 1324 and the application processor(s) (or processing circuitry) 1306 are each responsible for general processing, including the execution of software stored on the computer-readable medium/memory (or memory circuitry). The software, when executed by the cellular baseband processor(s) (or processing circuitry) 1324/application processor(s) (or processing circuitry) 1306, causes the cellular baseband processor(s) (or processing circuitry) 1324/application processor(s) (or processing circuitry) 1306 to perform the various functions described supra. The cellular baseband processor(s) (or processing circuitry) 1324 and the application processor(s) (or processing circuitry) 1306 are configured to perform the various functions described supra based at least in part of the information stored in the memory (or memory circuitry). That is, the cellular baseband processor(s) (or processing circuitry) 1324 and the application processor(s) (or processing circuitry) 1306 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1324/application processor(s) (or processing circuitry) 1306 when executing software. The cellular baseband processor(s) (or processing circuitry) 1324/application processor(s) (or processing circuitry) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) (or processing circuitry) 1324 and/or the application processor(s) (or processing circuitry) 1306, and in another configuration, the apparatus 1304 may be the entire UE (e.g., see UE 350 of FIG. 3) and include the additional modules of the apparatus 1304.

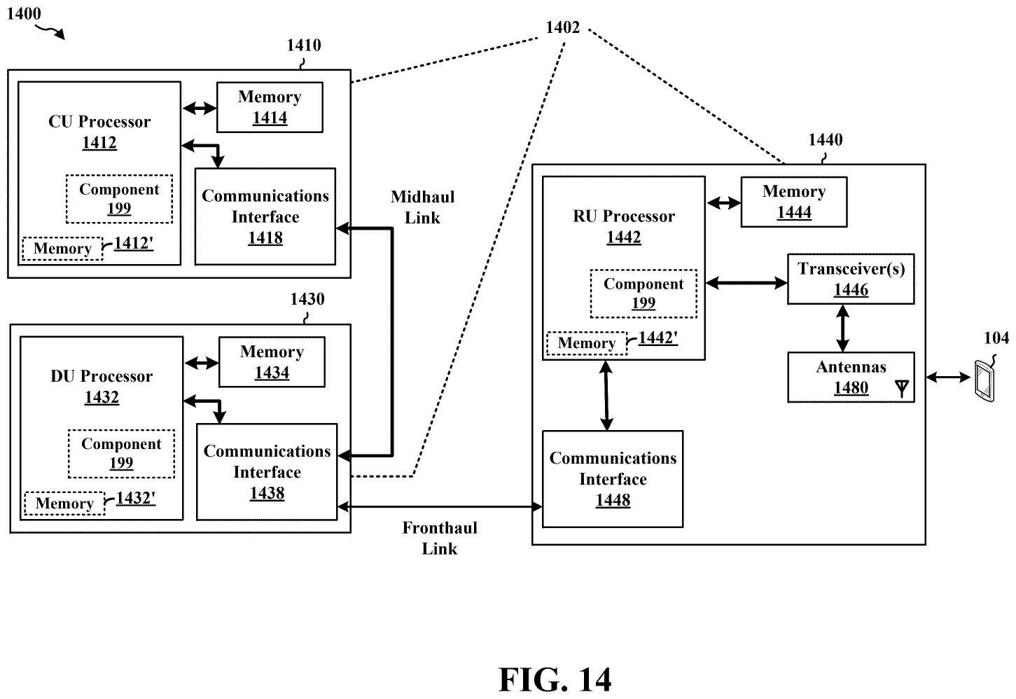

As discussed supra, the component 198 may be configured to receive, from a network entity, a first indication of a first set of random access resources for a first number of random access repetitions; receive an activation indication for a second set of random access resources different from the first set of random access resources; and transmit a second number of random access repetitions in random access resources from a random access repetition group based on at least the second set of random access resources. The component 198 may be further configured to perform any of the aspects described in connection with the flowcharts in FIG. 9 and FIG. 10, and/or performed by the UE 802 in FIG. 8. The component 198 may be within the cellular baseband processor(s) (or processing circuitry) 1324, the application processor(s) (or processing circuitry) 1306, or both the cellular baseband processor(s) (or processing circuitry) 1324 and the application processor(s) (or processing circuitry) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) (or processing circuitry) 1324 and/or the application processor(s) (or processing circuitry) 1306, includes means for receiving, from a network entity, a first indication of a first set of random access resources for a first number of random access repetitions, means for receiving an activation indication for a second set of random access resources different from the first set of random access resources, and means for transmitting a second number of random access repetitions in random access resources from a random access repetition group based on at least the second set of random access resources. The apparatus 1304 may further include means for performing any of the aspects described in connection with the flowcharts in FIG. 9 and FIG. 10, and/or aspects performed by the UE 802 in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means. FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor (or processing circuitry) 1412. The CU processor(s) (or processing circuitry) 1412 may include on-chip memory (or memory circuitry) 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor (or processing circuitry) 1432. The DU processor(s) (or processing circuitry) 1432 may include on-chip memory (or memory circuitry) 1432′. In some aspects, the DU 1430 may further include additional memory modules 1434 and a communications interface 1438. The DU 1430 communicates with the RU 1440 through a fronthaul link. The RU 1440 may include at least one RU processor (or processing circuitry) 1442. The RU processor(s) (or processing circuitry) 1442 may include on-chip memory (or memory circuitry) 1442′. In some aspects, the RU 1440 may further include additional memory modules 1444, one or more transceivers 1446, antennas 1480, and a communications interface 1448. The RU 1440 communicates with the UE 104. The on-chip memory (or memory circuitry) 1412′, 1432′, 1442′ and the additional memory modules 1414, 1434, 1444 may each be considered a computer-readable medium/memory (or memory circuitry). Each computer-readable medium/memory (or memory circuitry) may be non-transitory. Each of the processors (or processing circuitry) 1412, 1432, 1442 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, a first indication of a first set of random access resources for a first number of random access repetitions; transmit an activation indication for a second set of random access resources different from the first set of random access resources; and receive a second number of random access repetitions in random access resources from a random access repetition group. The random access repetition group may be based on at least the second set of random access resources. The component 199 may be further configured to perform any of the aspects described in connection with the flowcharts in FIG. 11 and FIG. 12, and/or performed by the base station 804 in FIG. 8. The component 199 may be within one or more processors (or processing circuitry) of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for transmitting, to a UE, a first indication of a first set of random access resources for a first number of random access repetitions, means for transmitting an activation indication for a second set of random access resources different from the first set of random access resources, and means for receiving a second number of random access repetitions in random access resources from a random access repetition group. The random access repetition group may be based on at least the second set of random access resources. The network entity 1402 may further include means for performing any of the aspects described in connection with the flowcharts in FIG. 11 and FIG. 12, and/or aspects performed by the base station 804 in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a first indication of a first set of random access resources for a first number of random access repetitions; receiving an activation indication for a second set of random access resources different from the first set of random access resources; and transmitting a second number of random access repetitions in random access resources from a random access repetition group based on at least the second set of random access resources. By enabling the UE to utilize newly configured PRACH resources to perform PRACH repetitions on the earliest available occasions, the methods reduce the latency of the PRACH procedure. Additionally, by forming PRACH repetition groups from both existing and newly configured PRACH resources, the methods enable the UE to perform extra PRACH repetitions, thereby improving the reliability of the PRACH procedure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a first indication of a first set of random access resources for a first number of random access repetitions; receiving an activation indication for a second set of random access resources different from the first set of random access resources; and transmitting a second number of random access repetitions in random access resources from a random access repetition group based on at least the second set of random access resources.

Aspect 2 is the method of aspect 1, wherein each random access resource in the first set of random access resources and the second set of random access resources corresponds to at least one random access occasion (RO).

Aspect 3 is the method of any of aspects 1 to 2, where the method further includes receiving, from the network entity, a second indication configuring the second set of random access resources.

Aspect 4 is the method of aspect 3, wherein the random access repetition group for the second number of random access repetitions is an additional repetition group for the second number of random access repetitions, and wherein resources for the second number of random access repetitions do not overlap with the first set of random access resources.

Aspect 5 is the method of aspect 4, wherein the activation indication includes a group indicator having a value that indicates that the resources for the second number of random access repetitions do not overlap with the first set of random access resources.

Aspect 6 is the method of aspect 3, wherein the random access repetition group for the second number of random access repetitions is based on a combination of the first set of random access resources and the second set of random access resources.

Aspect 7 is the method of aspect 6, wherein the activation indication includes a group indicator having a value that indicates that the random access repetition group is based on the combination.

Aspect 8 is the method of aspect 6, wherein the activation indication includes a scheme indicator, wherein the scheme indicator has one of a first value indicating that the random access repetition group is for reduced latency or a second value indicating that the random access repetition group is for increased reliability.

Aspect 9 is the method of aspect 6, wherein the combination of the first set of random access resources and the second set of random access resources is based on a grouping condition.

Aspect 10 is the method of aspect 9, wherein the grouping condition includes at least one of: the random access resources in the first set of random access resources are located at a same frequency range as the random access resources in the second set of random access resources, or each random access resource in the first set of random access resources is associated with a same preamble set as each random access resource in the second set of random access resources.

Aspect 11 is the method of aspect 7, wherein transmitting the second number of random access repetitions comprises: transmitting the second number of random access repetitions using earliest available random access resources in the combination of the first set of random access resources and the second set of random access resources.

Aspect 12 is the method of aspect 11, wherein the second number of random access repetitions equals the first number of random access repetitions.

Aspect 13 is the method of aspect 7, wherein transmitting the second number of random access repetitions comprises: transmitting the second number of random access repetitions in addition to the first number of random access repetitions in a time range of the first number of random access repetitions.

Aspect 14 is the method of aspect 13, wherein a summation of the first number of random access repetitions and the second number of random access repetitions is less than a threshold number.

Aspect 15 is the method of aspect 14, where the method further includes receiving, from the network entity, a threshold configuration indicative of the threshold number.

Aspect 16 is an apparatus for wireless communication at a UE, comprising: a processing system that includes processor circuitry and memory circuitry that stores code and is coupled with the processor circuitry, the processing system configured to cause the UE to perform the method of one or more of aspects 1-15.

Aspect 17 is an apparatus for wireless communication at a UE, comprising: at least one memory; and at least one processor coupled to the at least one memory and, where the at least one processor, individually or in any combination, is configured to perform the method of any of aspects 1-15.

Aspect 18 is the apparatus for wireless communication at a UE, comprising means for performing each step in the method of any of aspects 1-15.

Aspect 19 is an apparatus of any of aspects 16-18, further comprising a transceiver configured to receive or to transmit in association with the method of any of aspects 1-15.

Aspect 20 is a computer-readable medium (e.g., a non-transitory computer-readable medium) storing computer executable code at a UE, the code when executed by at least one processor causes the at least one processor to, individually or in any combination, perform the method of any of aspects 1-15.

Aspect 21 is a method of wireless communication at a network entity. The method includes transmitting, to a user equipment (UE), a first indication of a first set of random access resources for a first number of random access repetitions; transmitting an activation indication for a second set of random access resources different from the first set of random access resources; and receiving a second number of random access repetitions in random access resources from a random access repetition group, wherein the random access repetition group is based on at least the second set of random access resources.

Aspect 22 is the method of aspect 21, wherein each random access resource in the first set of random access resources and the second set of random access resources corresponds to at least one random access occasion (RO).

Aspect 23 is the method of any of aspects 21 to 22, where the method further includes transmitting, to the UE, a second indication configuring the second set of random access resources.

Aspect 24 is the method of aspect 23, wherein the random access repetition group for the second number of random access repetitions is an additional repetition group for the second number of random access repetitions, and wherein the resources for the second number of random access repetitions do not overlap with the first set of random access resources.

Aspect 25 is the method of aspect 24, wherein the activation indication includes a group indicator having a value that indicates that the resources for the second number of random access repetitions do not overlap with the first set of random access resources.

Aspect 26 is the method of any of aspects 21 to 23, wherein the random access repetition group for the second number of random access repetitions is based on a combination of the first set of random access resources and the second set of random access resources.

Aspect 27 is the method of aspect 26, wherein the activation indication includes a group indicator having a value that indicates that the random access repetition group is based on the combination.

Aspect 28 is the method of any of aspects 26 to 27, wherein the activation indication includes a scheme indicator, wherein the scheme indicator has one of a first value indicating that the random access repetition group is for reduced latency or a second value indicating that the random access repetition group is for increased reliability.

Aspect 29 is the method of aspect 26, wherein the combination of the first set of random access resources and the second set of random access resources is based on a grouping condition.

Aspect 30 is the method of aspect 29, wherein the grouping condition includes at least one of: the random access resources in the first set of random access resources are located at a same frequency range as the random access resources in the second set of random access resources, or each random access resource in the first set of random access resources is associated with a same preamble set as each random access resource in the second set of random access resources.

Aspect 31 is the method of aspect 27, wherein the second number of random access repetitions use earliest available random access resources in the combination of the first set of random access resources and the second set of random access resources.

Aspect 32 is the method of aspect 31, wherein the second number of random access repetitions equals the first number of random access repetitions.

Aspect 33 is the method of aspect 27, wherein the second number of random access repetitions are in addition to the first number of random access repetitions in a time range of the first number of random access repetitions.

Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 21-33.

Aspect 35 is an apparatus for wireless communication at a network entity, comprising: at least one memory; and at least one processor coupled to the at least one memory and, where the at least one processor, individually or in any combination, is configured to perform the method of any of aspects 21-33.

Aspect 36 is the apparatus for wireless communication at a network entity, comprising means for performing each step in the method of any of aspects 21-33.

Aspect 37 is an apparatus of any of aspects 34-36, further comprising a transceiver configured to receive or to transmit in association with the method of any of aspects 21-33.

Aspect 38 is a computer-readable medium (e.g., a non-transitory computer-readable medium) storing computer executable code at a network entity, the code when executed by at least one processor causes the at least one processor to, individually or in any combination, perform the method of any of aspects 21-33.

What is claimed is:

1. An apparatus of wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive, from a network entity, a first indication of a first set of random access resources for a first number of random access repetitions;
receive an activation indication for a second set of random access resources different from the first set of random access resources; and
transmit a second number of random access repetitions in random access resources from a random access repetition group based on at least the second set of random access resources.

2. The apparatus of claim 1, further comprising a transceiver coupled to the at least one processor, wherein to receive the first indication, the at least one processor, individually or in any combination, is configured to cause the UE to receive the first indication via the transceiver, and wherein each random access resource in the first set of random access resources and the second set of random access resources corresponds to at least one random access occasion (RO).

3. The apparatus of claim 2, wherein the at least one processor, individually or in any combination, is further configured to cause the UE to:
receive, from the network entity, a second indication configuring the second set of random access resources.

4. The apparatus of claim 3, wherein the random access repetition group for the second number of random access repetitions is an additional repetition group for the second number of random access repetitions, and wherein resources for the second number of random access repetitions do not overlap with the first set of random access resources.

5. The apparatus of claim 4, wherein the activation indication includes a group indicator having a value that indicates that the resources for the second number of random access repetitions do not overlap with the first set of random access resources.

6. The apparatus of claim 3, wherein the random access repetition group for the second number of random access repetitions is based on a combination of the first set of random access resources and the second set of random access resources.

7. The apparatus of claim 6, wherein the activation indication includes a group indicator having a value that indicates that the random access repetition group is based on the combination.

8. The apparatus of claim 6, wherein the activation indication includes a scheme indicator, wherein the scheme indicator has one of a first value indicating that the random access repetition group is for reduced latency or a second value indicating that the random access repetition group is for increased reliability.

9. The apparatus of claim 6, wherein the combination of the first set of random access resources and the second set of random access resources is based on a grouping condition.

10. The apparatus of claim 9, wherein the grouping condition includes at least one of:
the random access resources in the first set of random access resources are located at a same frequency range as the random access resources in the second set of random access resources, or
each random access resource in the first set of random access resources is associated with a same preamble set as each random access resource in the second set of random access resources.

11. The apparatus of claim 7, wherein to transmit the second number of random access repetitions, the at least one processor, individually or in any combination, is configured to cause the UE to:
transmit the second number of random access repetitions using earliest available random access resources in the combination of the first set of random access resources and the second set of random access resources.

12. The apparatus of claim 11, wherein the second number of random access repetitions equals the first number of random access repetitions.

13. The apparatus of claim 7, wherein to transmit the second number of random access repetitions, the at least one processor, individually or in any combination, is configured to cause the UE to:
transmit the second number of random access repetitions in addition to the first number of random access repetitions in a time range of the first number of random access repetitions.

14. The apparatus of claim 13, wherein a summation of the first number of random access repetitions and the second number of random access repetitions is less than a threshold number.

15. The apparatus of claim 14, wherein the at least one processor, individually or in any combination, is further configured to cause the UE to:
receive, from the network entity, a threshold configuration indicative of the threshold number.

16. An apparatus of wireless communication at a network entity, comprising:
at least one memory; and
at least one processor coupled to the at least one memory and, based at least in part on information stored in the at least one memory, the at least one processor, individually or in any combination, is configured to cause the network entity to:
transmit, to a user equipment (UE), a first indication of a first set of random access resources for a first number of random access repetitions;
transmit an activation indication for a second set of random access resources different from the first set of random access resources; and
receive a second number of random access repetitions in random access resources from a random access repetition group, wherein the random access repetition group is based on at least the second set of random access resources.

17. The apparatus of claim 16, further comprising a transceiver coupled to the at least one processor, wherein to transmit the first indication, the at least one processor, individually or in any combination, is configured to cause the network entity to transmit the first indication via the transceiver, and wherein each random access resource in the first set of random access resources and the second set of random access resources corresponds to at least one random access occasion (RO).

18. The apparatus of claim 17, wherein the at least one processor, individually or in any combination, is further configured to cause the network entity to:
transmit, to the UE, a second indication configuring the second set of random access resources.

19. The apparatus of claim 18, wherein the random access repetition group for the second number of random access repetitions is an additional repetition group for the second number of random access repetitions, and wherein resources for the second number of random access repetitions do not overlap with the first set of random access resources.

20. The apparatus of claim 19, wherein the activation indication includes a group indicator having a value that indicates that resources for the second number of random access repetitions do not overlap with the first set of random access resources.

21. The apparatus of claim 18, wherein the random access repetition group for the second number of random access repetitions is based on a combination of the first set of random access resources and the second set of random access resources.

22. The apparatus of claim 21, wherein the activation indication includes a group indicator having a value that indicates that the random access repetition group is based on the combination.

23. The apparatus of claim 21, wherein the activation indication includes a scheme indicator, wherein the scheme indicator has one of a first value indicating that the random access repetition group is for reduced latency or a second value indicating that the random access repetition group is for increased reliability.

24. The apparatus of claim 21, wherein the combination of the first set of random access resources and the second set of random access resources is based on a grouping condition.

25. The apparatus of claim 24, wherein the grouping condition includes at least one of:
the random access resources in the first set of random access resources are located at a same frequency range as the random access resources in the second set of random access resources, or
each random access resource in the first set of random access resources is associated with a same preamble set as each random access resource in the second set of random access resources.

26. The apparatus of claim 22, wherein the second number of random access repetitions use earliest available random access resources in the combination of the first set of random access resources and the second set of random access resources.

27. The apparatus of claim 26, wherein the second number of random access repetitions equals the first number of random access repetitions.

28. The apparatus of claim 22, wherein the second number of random access repetitions are in addition to the first number of random access repetitions in a time range of the first number of random access repetitions.

29. A method of wireless communication at a user equipment (UE), comprising:
receiving, from a network entity, a first indication of a first set of random access resources for a first number of random access repetitions;
receiving an activation indication for a second set of random access resources different from the first set of random access resources; and
transmitting a second number of random access repetitions in random access resources from a random access repetition group based on at least the second set of random access resources.

30. A method of wireless communication at a network entity, comprising:
transmitting, to a user equipment (UE), a first indication of a first set of random access resources for a first number of random access repetitions;
transmitting an activation indication for a second set of random access resources different from the first set of random access resources; and
receiving a second number of random access repetitions in random access resources from a random access repetition group, wherein the random access repetition group is based on at least the second set of random access resources.
